(19) United States
(12) Patent Application Publication
(10) Pub. No.: US 2025/0202022 A1
(43) Pub. Date: Jun. 19, 2025

(54) BATTERY MODULE COMPRISING MODULE COVER AND BATTERY PACK COMPRISING THE SAME

(71) Applicant: SK On Co., Ltd., Seoul (KR)

(72) Inventors: Ji San KIM, Daejeon (KR); Su In KIM, Daejeon (KR); Hyun Seong NOH, Daejeon (KR); Da Som PARK, Daejeon (KR)

(21) Appl. No.: 18/955,972

(22) Filed: Nov. 22, 2024

(30) Foreign Application Priority Data
Dec. 19, 2023 (KR) 10-2023-0185606

(51) Int. Cl. H01M 50/282; H01M 50/276; H01M 50/278; H01M 50/358

(52) U.S. Cl. CPC H01M 50/282; H01M 50/276; H01M 50/278; H01M 50/358

(57) ABSTRACT

A battery module including a cell assembly including a plurality of battery cells; a module housing accommodating the cell assembly; and a module cover connected to the module housing and covering at least a portion of the cell assembly, wherein the module cover includes a support member including a polymer, and a metal sheet disposed on the support member, and the support member is formed to have a first thickness, and the metal sheet is formed to have a second thickness, thinner than the first thickness, is disclosed.

### CROSS-REFERENCE TO RELATED APPLICATION(S)

This patent document claims the priority and benefits of Korean Patent Application No. 10-2023-0185606 filed on Dec. 19, 2023, the disclosure of which is incorporated herein by reference in its entirety.

### TECHNICAL FIELD

The disclosure and implementations disclosed in this patent document generally relate to a battery module including a module cover, and a battery pack including the same.

### BACKGROUND

Unlike a primary battery, a secondary battery may be charged and discharged, and thus may be applied to devices within various fields such as a digital camera, a mobile phone, a laptop computer, a hybrid vehicle, an electric vehicle, and an energy storage system (ESS). The secondary battery may be a lithium-ion battery, a nickel-cadmium battery, a nickel-metal hydride battery, or a nickel-hydrogen battery.

The secondary battery may be manufactured as a flexible pouch type battery cell or a rigid square or cylindrical can type battery cell. A plurality of battery cells may be formed as a cell assembly in a stacked form.

The cell assembly may be disposed in a case to form a battery module, and a plurality of battery modules may be disposed in pack frame to form a battery pack. The battery pack may be used in various structures such as a vehicle or an energy storage system.

### SUMMARY

A battery module may include a module cover covering at least a portion of a cell assembly. In an embodiment, a module cover formed of a polymer material may be used. The module cover formed of the polymer material may melt in a thermal runaway situation. In the case that the module cover melts, flames and conductive particles may spread to generate a short circuit and heat transfer. In another embodiment, a module cover formed of a metal (e.g., aluminum) material may be used. Since weight of the module cover formed of the metal material may be greater than weight of a module cover formed of a plastic material, an energy density of the battery module may be reduced.

In the case that the module cover formed of the polymer material is used, an additional component (e.g., flame retardant component) may be required to prevent melting of the module cover. In the case that the module cover formed of the metal material is used, an additional component (e.g., insulating component and flame retardant component) may be required to secure insulation stability and melting stability of the module cover. The additional components may increase manufacturing costs and weight of the battery module.

According to an aspect of the disclosure of this patent document, a battery module and a battery pack, maintaining shapes thereof and being lightweight in a high-temperature situation (e.g., thermal runaway situation), may be provided.

According to an aspect of the disclosure of this patent document, a battery module and a battery pack, not requiring an additional insulating component and a flame-retardant component, may be provided.

A battery module and a battery pack of the disclosure of this patent document may be widely applied in green technology fields such as an electric vehicle, a battery charging station, as well as solar power generation and wind power generation using batteries. In addition, a battery module and a battery pack of the disclosure of this patent document may be used in an eco-friendly electric vehicle, a hybrid vehicle, or the like, to prevent a change in climate by suppressing air pollution and greenhouse gas emissions.

In some embodiments of the disclosure of this patent document, a battery module includes a cell assembly including a plurality of battery cells; a module housing accommodating the cell assembly; and a module cover connected to the module housing and covering at least a portion of the cell assembly. The module cover may include a support member including a polymer, and a metal sheet disposed on the support member. The support member may be formed to have a first thickness, and the metal sheet may be formed to have a second thickness, thinner than the first thickness.

According to an embodiment, the second thickness may be 0.01 mm to 1.0 mm.

According to an embodiment, the module cover may include a plurality of venting holes. Each of the plurality of venting holes may include a first venting portion formed in the support member, and a second venting portion formed in the metal sheet and overlapping at least a portion of the first venting portion.

According to an embodiment, the support member may include a first uneven pattern, and the metal sheet may include a second uneven pattern interlocked with the first uneven pattern.

According to an embodiment, the polymer may include at least one of polypropylene, polyethylene, polycarbonate, polycarbonate acrylonitrile butadiene styrene, or modified polyphenylene oxide.

According to an embodiment, the metal sheet may include stainless steel.

In an embodiment, the metal sheet may include a through-hole. The support member may include a support portion, and a protrusion portion extending from the support portion and exposed to an outside of the module cover through the through-hole.

In an embodiment, the module cover may include a fastening member connecting the support member and the metal sheet.

In an embodiment, the module cover may include an adhesive layer located between the support member and the metal sheet.

In an embodiment, the cell assembly may face at least a portion of the support member. the support member may be located between the metal sheet and the cell assembly.

In an embodiment, a first density of the support member may be lower than a second density of the metal sheet.

A battery pack of the disclosure of this patent document may include a plurality of battery modules, and a pack frame accommodating the plurality of battery modules. Each of the plurality of battery modules may include a cell assembly including a plurality of battery cells, a module housing accommodating the cell assembly, and a module cover connected to the module housing and covering at least a portion of the cell assembly. The module cover may include a support member including a polymer, and a metal sheet disposed on the support member.

A battery pack of the disclosure of this patent document may include a plurality of battery modules, and a pack frame accommodating the plurality of battery modules. The pack frame may include a bottom member supporting the plurality of battery modules, and a pack cover covering the plurality of battery modules. The pack cover may include a support member including a polymer, and a metal sheet disposed on the support member.

### BRIEF DESCRIPTION OF DRAWINGS

Certain aspects, features, and advantages of the disclosure of this patent document may be illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of a battery module according to an embodiment.

FIG. 4 is a schematic perspective view of a module cover according to an embodiment.

FIGS. 5A, 5B, and 5C are cross-sectional views of a module cover according to various embodiments.

FIGS. 6A and 6B are top views of a metal sheet according to various embodiments. FIG. 6C is a cross-sectional view of a module cover according to an embodiment.

FIG. 7A is a top view of a module cover including a venting hole according to an embodiment. FIG. 7B is a cross-sectional view of a module cover including a venting hole according to an embodiment.

FIG. 8 is an exploded perspective view of a battery pack according to an embodiment.

### DETAILED DESCRIPTION

Hereinafter, the disclosure of this patent document will be described in detail with reference to the attached drawings. However, this is merely illustrative and the disclosure of this patent document is not limited to the specific embodiments described by way of example.

Terms or words used in the specification and claims described below may not be to be construed as limited to their ordinary or dictionary meanings. The inventor will interpret the meaning and concept consistent with the technical idea of the disclosure of this patent document based on the principle that the concept of the term is appropriately defined in order to explain the disclosure of this patent document in the best manner.

Accordingly, the embodiments described in this specification and the configurations illustrated in the drawings may be only the most preferred embodiments of the disclosure of this patent document, and do not represent the entire technical idea of the disclosure of this patent document, and it will be appreciated that there are various equivalents and variations may be substituted therefor at the time of filing the disclosure of this patent document. Detailed descriptions of well-known functions and

configurations that may obscure the gist of the disclosure of this patent document may be omitted. In the attached drawings, some components may be exaggerated, omitted, or schematically illustrated, and a size of each of the components does not entirely reflect an actual size thereof.

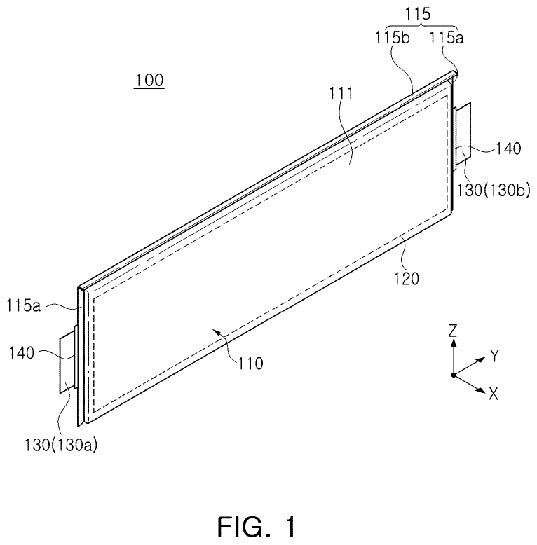

FIG. 1 is a perspective view of a battery cell according to an embodiment.

Referring to FIG. 1, a battery cell 100 may include a pouch 110, an electrode assembly 120, and an electrode tab 130. The battery cell 100 may be a secondary battery. For example, the battery cell 100 may be a lithium-ion battery, but the disclosure of this patent document is not limited thereto. For example, the battery cell 100 may be a nickel-cadmium battery, a nickel-metal hydride battery, or a nickel-hydrogen battery, capable of being charged and discharged.

The pouch 110 may form at least a portion of an exterior of the battery cell 100. The pouch 110 may include an electrode accommodating portion 111 accommodating the electrode assembly 120, and a sealing portion 115 sealing at least a portion of a circumference of the electrode accommodating portion 111. The electrode accommodating portion 111 may provide a space accommodating the electrode assembly 120 and an electrolyte solution.

The sealing portion 115 may be formed by joining at least a portion of a circumference of the pouch 110. The sealing portion 115 may be formed in a flange shape extending outward from the electrode accommodating portion 111 formed in a container shape, and may be disposed along at least a portion of an external boundary of the electrode accommodating portion 111. In an embodiment, the sealing portion 115 may include a first sealing portion 115a in which the electrode tab 130 is located, and a second sealing portion 115b in which the electrode tab 130 is not located. A portion of the electrode tab 130 may be drawn out or exposed to an outside of the pouch 110. In a position in which the electrode tab 130 is drawn out, to increase a sealing degree of the first sealing portion 115a and, at the same time, ensure an electrical insulation state, the electrode tab 130 may be covered by an insulating film 140. The insulating film 140 may be formed of a film material having a thickness, smaller than a thickness of the electrode tab 130, and may be attached to both surfaces of the electrode tab 130.

In an embodiment, the electrode tabs 130 may be arranged on both sides of the battery cell 100 in a longitudinal direction (Y-axis direction) to face in opposite directions. For example, the electrode tab 130 may include a positive lead 130a of a first polarity (e.g., positive electrode) facing one side of the battery cell 100 in the longitudinal direction, and a negative lead 130b of a second polarity (e.g., negative electrode) facing the other side of the battery cell 100 in the longitudinal direction. In the embodiment illustrated in FIG. 1, the sealing portion 115 may include two first sealing portions 115a on which the electrode tab 130 is disposed, and one second sealing portion 115b on which the electrode tab 130 is not disposed. In an embodiment, the electrode tab 130 may be referred to as an electrode lead.

A direction in which the electrode tab 130 is located may be selectively designed. In an embodiment (e.g., FIG. 1), the electrode tab 130 may include the first electrode lead 130a, and the second electrode lead 130b located in a direction, opposite to the first electrode lead 130a, based on the electrode assembly 120. In FIG. 1, the electrode tabs 130 are illustrated to face opposite directions on both sides of the battery cell 100 in the longitudinal direction, but structures of the electrode tabs 130 are not limited thereto. For example, the two electrode tabs 130 may be arranged substantially in parallel in the longitudinal direction of the battery cell 100.

The pouch 110 is not limited to a structure in which the sealing portion 115 is formed on three surfaces by folding a single sheet of exterior material, as illustrated in FIG. 1.

In an embodiment of the disclosure of this patent document, at least a portion of the sealing portions 115 may be formed to be folded at least once. At least a portion of the sealing portion 115 may be folded to improve coupling reliability of the sealing portion 115 and minimize an area of the sealing portion 115. Among the sealing portions 115 according to an embodiment, the second sealing portion 115b on which the electrode tab 130 is not disposed may be folded twice and then fixed by an adhesive member (not illustrated). An angle at which the second sealing portion 115b is bent or the number of times which the second sealing portion 115b is bent may be changed. For example, in an embodiment not illustrated, the second sealing portion 115b may be folded by 90° with respect to the first sealing portion 115a.

The electrode assembly 120 may include a cathode plate, an anode plate, and a separator. The separator may prevent contact between the cathode plate and the anode plate. Those skilled in the art will understand that the electrode assembly 120 may be manufactured using a variety of methods. According to example embodiments, an electrode assembly may be formed by repeatedly arranging a cathode, an anode, and a separator. In some embodiments, the electrode assembly may be of a winding type, a stacking type, a zigzag folding type, or a stack-folding type.

A structure of the battery cell 100 illustrated in FIG. 1 is illustrative. For example, in FIG. 1, the battery cell 100 is described as a pouch type battery cell, but the structure of the battery cell 100 is not limited thereto. For example, the battery cell 100 may be a cylindrical battery cell or a square battery cell.

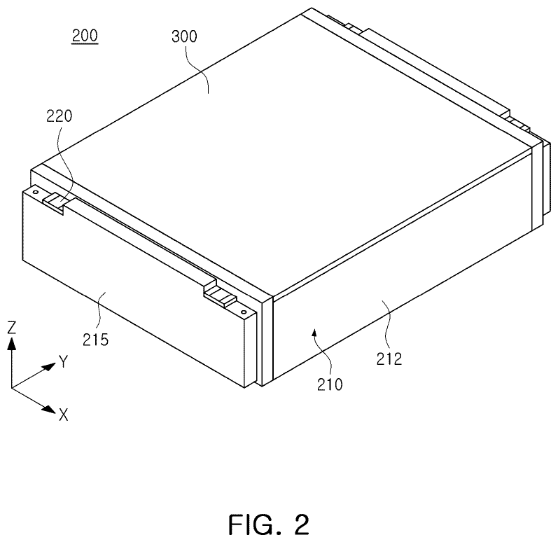

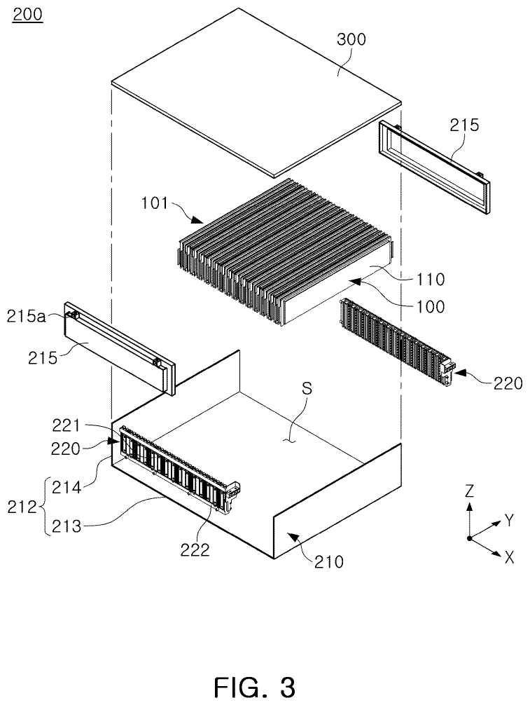

FIG. 2 is a perspective view of a battery module according to an embodiment. FIG. 3 is an exploded perspective view of a battery module according to an embodiment.

Referring to FIG. 2 and/or FIG. 3, a battery module 200 may include a cell assembly 101 including a plurality of battery cells 100, a module housing 210, a busbar assembly 220, and a module cover 300. At least a portion of the description of the battery cell 100 of FIG. 1 may be applied to the battery cell 100 of FIG. 3.

The module housing 210 may form at least a portion of an exterior of the battery module 200, and may form an internal space S that accommodates the cell assembly 101 and/or the busbar assembly 220.

The module housing 210 may include an accommodating portion 212 that surrounds a lower surface and a side surface of the cell assembly 101. The accommodating portion 212 may include a main plate 213 covering the lower surface of the cell assembly 101, and a plurality of side wall members 214 covering at least a portion of the side surface of the cell assembly 101. At least a portion of the internal space S may be surrounded by the main plate 213, the side wall members 214, and an end plate 215.

The module housing 210 may include the end plate 215 covering a portion of the side surface of the cell assembly 101. In an embodiment, the end plate 215 may be connected to an end portion in a longitudinal direction (e.g., Y-axis direction) of the accommodating portion 212. The end plate 215 may cover a portion of the side surface of the cell assembly 101 and the busbar assembly 220. The end plate 215 may include a hole 215a for accommodating a connection terminal of the busbar assembly 220.

In an embodiment, the module housing 210 may be formed of a material having high thermal conductivity, such as metal. For example, the module housing 210 may be formed of aluminum and/or stainless steel. The material of the module housing 210 is not limited thereto. In another embodiment, the module housing 210 may be formed of a polymer. The module housing 210 may be referred to as a housing, a case, or a module case.

The busbar assembly 220 may include a busbar 221 having electrical conductivity and electrically connected to an electrode tab (e.g., electrode tab 130 of FIG. 1) of a battery cell 100, and a busbar frame 222 supporting the busbar. The busbar assembly 220 may include at least one connection terminal for electrical connection with an external source. The electrode tab 130 of the battery cell 100 may be electrically connected to an outside of the battery module 200 through the busbar 221 and the connection terminal.

The module cover 300 may form at least a portion of an exterior of the battery module 200, together with the module housing 210. For example, the module cover 300 may be connected to the module housing 210, and may surround at least a portion of the cell assembly 101. The module cover 300 may be disposed at one side of the cell assembly 101, and may cover the cell assembly 101. A specific structure of the module cover 300 may be further described below.

For convenience of explanation, some portions may be omitted or exaggerated in this document. For example, the number of battery cells 100 and/or a shape of the busbar assembly 220 may be selectively designed. According to an embodiment not illustrated, the battery module 200 may include a conductive member (e.g., long busbar) for adjusting a position of the connection terminal of the busbar assembly 220.

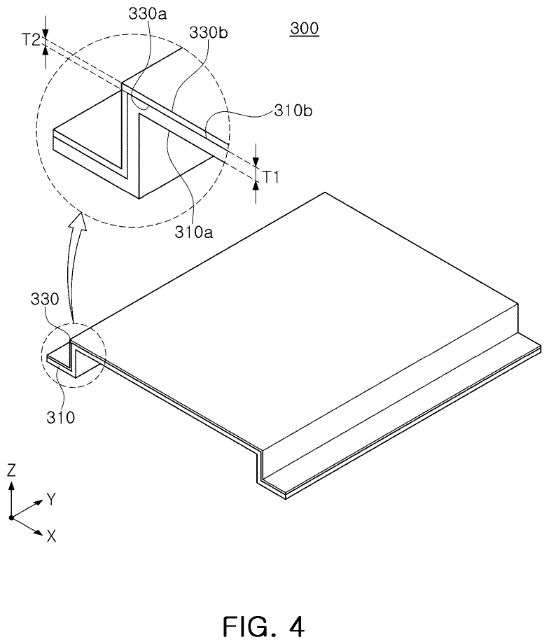

FIG. 4 is a schematic perspective view of a module cover according to an embodiment.

Referring to FIG. 4, a module cover 300 may include a support member 310 and a metal sheet 330. At least a portion of the description of the module cover 300 of FIG. 2 and/or FIG. 3 may be applied to the module cover 300 of FIG. 4.

The module cover 300 may include the support member 310 including a polymer, and the metal sheet 330 disposed on the support member 310. The metal sheet 330 may cover at least a portion of the support member 310. The metal sheet 330 may form at least a portion of an exterior of a battery module 200. For example, the metal sheet 330 may form at least a portion of an exterior of the module cover 300, and may be exposed to the exterior of the battery module 200.

The support member 310 may include a first surface 310a facing an interior space of the battery module 200 (e.g., interior space S of FIG. 3) and/or a cell assembly (e.g., cell assembly 101 of FIG. 3), and a second surface 310b opposing the first surface 310a. At least a portion of the support member 310 may face the cell assembly 101. At least a portion of the support member 310 may be located between the cell assembly 101 and the metal sheet 330.

In an embodiment, the first surface 310a may be referred to as an inner surface of the support member 310, and the second surface 310b may be referred to as an outer surface of the support member 310. The metal sheet 330 may include a third surface 330a facing at least a portion of the second surface 310b of the support member 310, and a fourth surface 330b opposing the third surface 330a and facing the exterior of the module cover 300. In an embodiment, the third surface 330a may be referred to as an inner surface of the metal sheet 330, and the fourth surface 330b may be referred to as an outer surface of the metal sheet 330.

The support member 310 may be formed of a material having substantial insulation and a low density. For example, the support member 310 may include a polymer. A first density of the support member 310 may be lower than a second density of the metal sheet 330. For example, the support member 310 may include a polymer material having a low density. In an embodiment, the polymer of the support member 310 may include at least one of polypropylene, polyethylene, polycarbonate, polycarbonate acrylonitrile butadiene styrene, or modified polyphenylene oxide (MPPO). Since the support member 310 may be formed of the polymer, a density of the module cover 300 of the disclosure of this patent document may be lower than a density of a module cover formed entirely of metal. Weight of the battery module 200 may be reduced, and an energy density of the battery module 200 may increase.

Due to the support member 310, an insulating component located between the cell assembly (e.g., cell assembly 101 of FIG. 3) and the module cover 300 in the battery module 200 may not be required. Since the insulating component may not be required, weight and production costs of the battery module 200 may be reduced, and an energy density per weight may increase.

The metal sheet 330 may maintain rigidity of the battery module 200, and may protect the module cover 300 from flames and/or gas transmitted from an outside of the battery module 200. The metal sheet 330 may be manufactured from a material having heat resistance and rigidity. In an embodiment, the metal sheet 330 may include stainless steel (e.g., stainless steel 304 and/or stainless steel 430). In an embodiment, the metal sheet 330 may be manufactured by temper rolling. In an embodiment, the metal sheet 330 may be replaced with a material having a melting point of 1000° C., in addition to stainless steel.

In an embodiment, the metal sheet 330 may be formed to be thinner than the support member 310. For example, a second thickness T2 of the metal sheet 330 may be thinner than a first thickness T1 of the support member 310. In an embodiment, the second thickness T2 may be 0.01 mm to 1.0 mm. By forming the second thickness T2 to be 0.01 mm or more, rigidity of the metal sheet 330 may be maintained. When thermal runaway occurs in the battery module (e.g., battery module 200 of FIG. 2), breakage or tearing of the metal sheet 330 may be reduced or prevented. By forming the second thickness T2 to be 1.00 mm or less, a decrease in weight of the module cover 300 may be implemented. A ratio of the first thickness T1 of the support member 310 and the second thickness T2 of the metal sheet 330 may be selectively changed based on structural strength required for the module cover 300, a material of the support member 310, and a material of the metal sheet 330.

TABLE 1

| | | | | | Weigh |
|---|---|---|---|---|---|
| | | | | Insulation | Improve- |
| | | Density | Melting | Per- | ment |
| | Material | (g/cm³) | Stability | formance | Rate |
| 1^{st} Com- | Aluminum | 2.7 | x | x | 0% |
| parative | | | | | |
| Example | | | | | |
| 2^{nd} Com- | Poly- | 1.2 | x | ○ | 55.6% |
| parative | carbonate | | | | |
| Example | | | | | |
| 1^{st} | Stainless | 1.42 | ○ | ○ | 47.4% |
| Inventive | Steel & Poly- | | | | |
| Example | carbonate | | | | |
| 2^{nd} | Stainless | 2.09 | ○ | ○ | 22.6% |
| Inventive | Steel & Poly- | | | | |
| Example | carbonate | | | | |

Referring to [Table 1], a module cover 300 may have different characteristics, depending on a material and a thickness. [Table 1] illustrates a density, melting stability, insulation performance, and a weight improvement rate according to a structure (e.g., material) of the module cover having a thickness of 3 mm. In an embodiment, a support member 310 and a metal sheet 330 of the module cover 300 may have thicknesses corresponding to [Table 1] above. The thickness of the module cover 300 may be illustrative, and the thickness of the module cover 300 may be changed, depending on a design of a battery module 200.

A first comparative example illustrates characteristics of a module cover formed of aluminum having a thickness of substantially 3 mm. In the first comparative example, a density of the module cover formed of aluminum having a thickness of 3 mm may be about 2.7 g/cm³. It was confirmed that the module cover of the first comparative example has no melting stability and no insulation performance. In the module cover of the first comparative example, an insulating component and a flame retardant component may be required. When the module cover of the first comparative example is used, three components including the module cover may be required.

A second comparative example illustrates characteristics of a module cover formed of polycarbonate having a thickness of substantially 3 mm. In the second comparative example, a density of the module cover formed of polycarbonate having a thickness of 3 mm may be about 1.2 g/cm³. Since the module cover may be formed of polycarbonate, weight of the module cover of the second comparative example may be lower than weight of the module cover of the first comparative example. For example, the weight of the module cover of the second comparative example may be about 55.6% lower than the weight of the module cover of the first comparative example. It was confirmed that the module cover of the second comparative example has insulation stability but no melting stability. In the module cover of the second comparative example, an insulating component may not be required, but a flame retardant component may be required. When the module cover of the second comparative example is used, two components including the module cover may be required.

Inventive examples of the disclosure of this patent document may include a module cover 300 including a support member 310 and a metal sheet 330 disposed on the support member 310.

A first inventive example illustrates characteristics of a module cover 300 including a metal sheet 330 formed of stainless steel (e.g., stainless steel 304) having a thickness of 0.1 mm, and a support member 310 formed of polycarbonate having a thickness of 2.9 mm. A density of the module cover 300 of the first inventive example may be about 1.42 g/cm³. Weight of the module cover 300 of the first inventive example may be about 47.4% lower than the weight of the module cover of the first comparative example. It was confirmed that the module cover 300 of the first inventive example has insulation stability and melting stability. In the module cover 300 of the first inventive example, an insulating component and a flame retardant component may not be required. Since an insulating component and a flame retardant component may not be required, manufacturing costs and/or weight of a battery module (e.g., battery module 200 of FIG. 2) including the module cover 300 of the first inventive example may be reduced, and an energy density may be improved.

A second inventive example illustrates characteristics of a module cover 300 including a metal sheet 330 formed of stainless steel (e.g., stainless steel 304) having a thickness of 0.4 mm, and a support member 310 formed of polycarbonate having a thickness of 2.6 mm. A density of the module cover 300 of the second inventive example may be about 2.09 g/cm³. Weight of the module cover 300 of the second inventive example may be about 22.6% lower than the weight of the module cover of the first comparative example. It was confirmed that the module cover 300 of the second inventive example has insulation stability and melting stability. In the module cover 300 of the second inventive example, an insulating component and a flame retardant component may not be required. Since an insulating component and a flame retardant component may not be required, manufacturing costs and/or weight of a battery module (e.g., battery module 200 of FIG. 2) including the module cover 300 of the second inventive example may be reduced, and an energy density may be improved.

A specific shape of the module cover 300 may be different. For example, although the module cover 300 having a total thickness of 3 mm is described in the disclosure of this patent document, the total thickness of the module cover 300 may be optional. In an embodiment, the module cover 300 may be formed to have a shape in which a portion is bent. In another embodiment (e.g., module cover 300 of FIG. 3), the module cover 300 may be formed to have a flat shape.

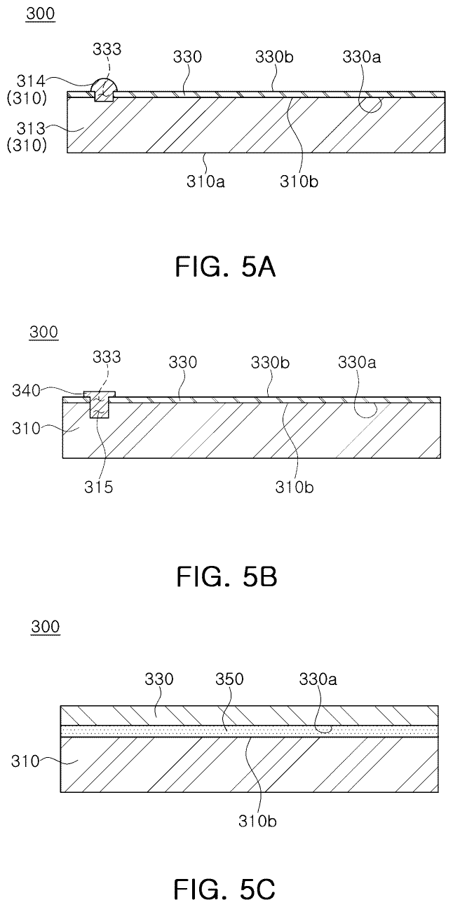

FIGS. 5A, 5B, and 5C are cross-sectional views of a module cover according to various embodiments. Referring to FIGS. 5A, 5B, and/or 5C, a module cover 300 may include a support member 310 and a metal sheet 330. The support member 310 and the metal sheet 330 may be coupled to each other. At least a portion of the descriptions of the module cover 300, the support member 310, and the metal sheet 330 of FIG. 4 may be applied to the module cover 300, the support member 310, and the metal sheet 330 of FIGS. 5A, 5B, and 5C.

According to an embodiment (e.g., FIG. 5A), a support member 310 and a metal sheet 330 may be coupled to each other using thermal fusion.

The support member 310 and the metal sheet 330 may have a shape for being coupled by thermal fusion. For example, the metal sheet 330 may include at least one through-hole 333. The support member 310 may include a support portion 313 supporting at least a portion of the metal sheet 330, and a protrusion portion 314 extending from the support portion 313 and in which at least a portion is inserted into the through-hole 333 of the metal sheet 330. The support portion 313 may form a first surface 310a and a second surface 310b of the support member 310. At least a portion of the protrusion portion 314 may pass through the through-hole 333 of the metal sheet 330, and may be exposed to an outside of a module cover 300. At least a portion of the protrusion portion 314 may cover a portion of a fourth surface 330b of the metal sheet 330. The through-hole 333 may be a hole penetrating a third surface 330a and the fourth surface 330b of the metal sheet 330. A portion of the support member 310 (e.g., protrusion portion 314) may be melted and then hardened by thermal fusion, to be coupled to the metal sheet 330. For example, the protrusion portion 314 may be formed integrally with the support portion 313. A portion of the metal sheet 330 (e.g., portion defining the through-hole 313) may be located between the support portion 313 and the protrusion portion 314. In an embodiment, the protrusion portion 314 may be referred to as a pin or a protrusion.

According to an embodiment (e.g., FIG. 5B), a module cover 300 may further include at least one fastening member 340. A support member 310 and a metal sheet 330 may be coupled by the fastening member 340. The fastening member 340 may be a bolt, a screw, and/or a rivet. For example, the metal sheet 330 may include at least one through-hole 333. The support member 310 may include an accommodating groove 315 for accommodating at least a portion of the fastening member 340. The accommodating groove 315 may be formed on a second surface 310b of the support member 310. The fastening member 340 may penetrate a portion of the metal sheet 330 (e.g., through-hole 333), and may be connected to at least a portion of the support member 310.

According to an embodiment (e.g., FIG. 5C), a module cover 300 may further include an adhesive layer 350. A support member 310 and a metal sheet 330 may be coupled by the adhesive layer 350. The adhesive layer 350 may be located between the support member 310 and the metal sheet 330. For example, the adhesive layer 350 may be attached to a second surface 310b of the support member 310 and a third surface 330a of the metal sheet 330. A type of the adhesive layer 350 may be optional. For example, the adhesive layer 350 may be at least one of an acrylic-based adhesive, a hot melt-based adhesive, a urethane-based adhesive, an epoxy-based adhesive, or a silicone-based adhesive. In an embodiment, the adhesive layer 350 may be referred to as an adhesive or an adhesive member.

In an embodiment, a support member 310 and a metal sheet 330 of a module cover 300 may be coupled using a plurality of structures. For example, in an embodiment, the module cover 300 may include at least one of the support portion 313, the protrusion portion 314, and the through-hole 333 of FIG. 5A, the fastening member 340 of FIG. 5B, or the adhesive layer 350 of FIG. 5C.

In an embodiment (not illustrated), a support member 310 and a metal sheet 330 of a module cover 300 may be coupled using a method not illustrated (e.g., injection molding, adhering, or laser processing).

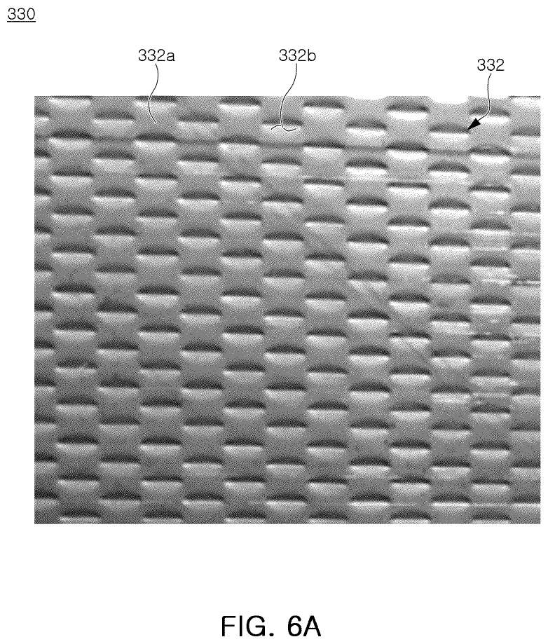

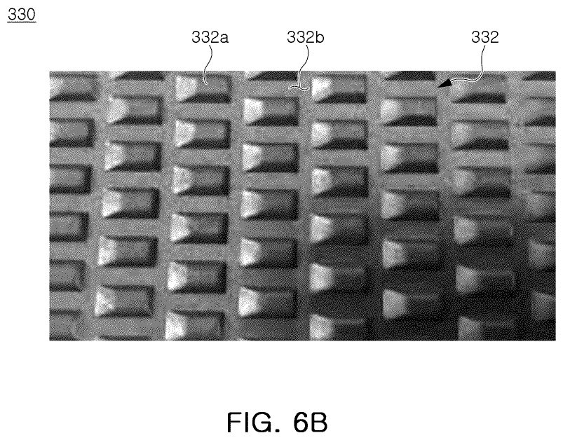

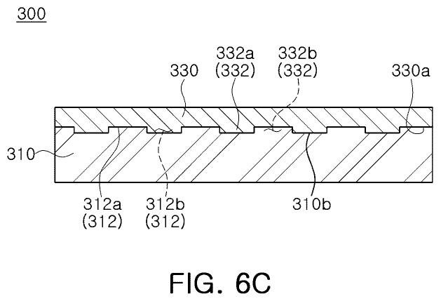

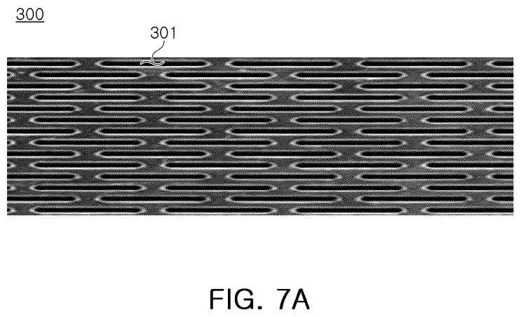

FIGS. 6A and 6B are top views of a metal sheet according to various embodiments. FIG. 6C is a cross-sectional view of a module cover according to an embodiment.

Referring to FIGS. 6A, 6B, and/or 6C, a support member 310 and a metal sheet 330 of a module cover 300 may be coupled to each other using a first uneven pattern 312 and/or a second uneven pattern 332. At least a portion of the description of the module cover 300, the support member 310, and the metal sheet 330 of FIG. 4 may be applied to the module cover 300, the support member 310, and the metal sheet 330 of FIGS. 6A, 6B, and/or 6C. In an embodiment, the first uneven pattern 312 may be referred to as a first embossment structure, and the second uneven pattern 332 may be referred to as a second embossment structure.

The support member 310 may include the first uneven pattern 312 formed on a second surface 310b of the support member 310. The first uneven pattern 312 may include a plurality of first protrusion portions 312a and a plurality of first grooves 312b. A first groove 312b may be a portion of the second surface 310b of the support member 310 on which a first protrusion portion 312a is not formed.

In an embodiment, the first uneven pattern 312 may be formed by using injection molding using a mold corresponding to a shape of the first uneven pattern 312, and/or insert injection molding using a pressurizing device (e.g., press) corresponding to the shape of the first uneven pattern 312, and/or the metal sheet 330 including the second uneven pattern 332.

The metal sheet 330 may include the second uneven pattern 332 formed on a third surface 330a of the metal sheet 330. The second uneven pattern 332 may include a plurality of second protrusion portions 332a and a plurality of second grooves 332b. A second grooves 332b may be a portion of the third surface 330a of the metal sheet 330 on which a protrusion portion 332a is not formed.

The shape of the first uneven pattern 312 of the support member 310 may be formed to correspond to the second uneven pattern 332 of the metal sheet 330. For example, a structure of the second uneven pattern 332 illustrated in FIG. 6A or FIG. 6B may be symmetrically applied to the first uneven pattern 312 of the support member 310. For example, the second uneven pattern 332 may be interlocked with the first uneven pattern 312. The plurality of second protrusion portions 332a may be inserted into the plurality of first grooves 312b, and the plurality of first protrusion portions 312a may be inserted into the plurality of second grooves 332b. Since the support member 310 and the metal sheet 330 may be interlocked with each other and combined, an empty space between the support member 310 and the metal sheet 330 may be reduced. The second uneven pattern 332 may improve rigidity of the metal sheet 330.

In an embodiment, the second uneven pattern 332 may be formed by using a pressurizing device (e.g., roller and/or a press) including a protrusion corresponding to the shape of the second uneven pattern 332.

By the first uneven pattern 312 and the second uneven pattern 332, a contact area between the support member 310 and the metal sheet 330 may increase. Due to an increase in contact area, coupling force (e.g., coupling force in horizontal and vertical directions) between the support member 310 and the metal sheet 330 of the module cover 300 may be improved, and structural reliability of the module cover 300 may increase.

In an embodiment, the support member 310 and the metal sheet 330 may be coupled by frictional force (e.g., force fitting) of the first uneven pattern 312 and the second uneven pattern 332.

In an embodiment, the support member 310 and the metal sheet 330 may include a structure (e.g., at least one of the support portion 313, the protrusion portion 314, and the through-hole 333 of FIG. 5A, the fastening member 340 of FIG. 5B, or the adhesive layer 350 of FIG. 5C) for coupling the support member 310 and the metal sheet 330 of FIGS. 5A, 5B, and/or 5C, together with the first uneven pattern 312 and the second uneven pattern 332. By using the support portion 313, the protrusion portion 314, and the through-hole 333 of FIG. 5A, the fastening member 340 of FIG. 5B, or the adhesive layer 350 of FIG. 5C, together with the first uneven pattern 312 and the second uneven pattern 332, coupling force between the support member 310 and the metal sheet 330 may be improved.

The shapes of the first uneven pattern 312 and the second uneven pattern 332 may be illustrative. For example, in an embodiment (e.g., FIG. 6A), the second uneven pattern 312 may have an elliptical cross-section. In an embodiment (e.g., FIG. 6B), the second uneven pattern 332 may have a rectangular cross-section. In an embodiment not illustrated, the first uneven pattern 312 and/or the second uneven pattern 332 may have a circular, trapezoidal, and/or amorphous cross-section.

In an embodiment (not illustrated), the support member 310 may not include the first uneven pattern 312, and the metal sheet 330 may include the second uneven pattern 332. Due to the second uneven pattern 332, the rigidity of the metal sheet 330 may be improved. The module cover 300 not including the first uneven pattern 312, but including the second uneven pattern 332 may include a structure for coupling the support member 310 and the metal sheet 330 of FIG. 5A, FIG. 5B, and/or FIG. 5C.

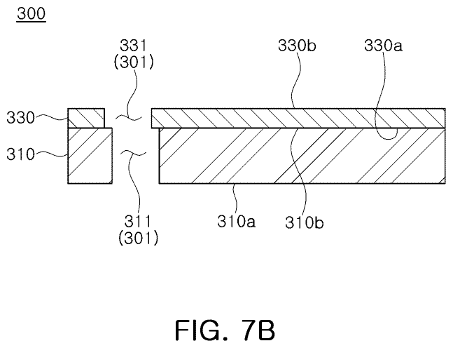

FIG. 7A is a top view of a module cover including a venting hole according to an embodiment. FIG. 7B is a cross-sectional view of a module cover including a venting hole according to an embodiment.

Referring to FIG. 7A and/or FIG. 7B, a module cover 300 may include a venting hole 301. At least a portion of the descriptions of the module cover 300, the support member 310, and the metal sheet 330 of FIG. 4, FIG. 5A, FIG. 5B, FIG. 5C, FIG. 6A, FIG. 6B, and/or FIG. 6C may be applied to the module cover 300, a support member 310, and a metal sheet 330 of FIG. 7A and/or FIG. 7B.

The module cover 300 may include a plurality of venting holes 301. The venting hole 301 may provide a path for gas, flames, and/or conductive particles generated from a battery cell (e.g., battery cell 101 of FIG. 1) to be discharged from a battery module (e.g., battery module 200 of FIG. 2). Shapes, sizes, the number, and/or arrangement of the venting holes 301 illustrated in FIG. 7A and/or FIG. 7B are illustrative. For example, the venting holes 301 may be formed to have a circular, oval, and/or rectangular shape.

Each of the plurality of venting holes 301 may include a first venting portion 311 formed in the support member 310 and a second venting portion 331 formed in the metal sheet 330.

In an embodiment, the first venting portion 311 may be an empty space penetrating a first surface 310a and a second surface 310b of the support member 310. The second venting portion 331 may be an empty space penetrating a third surface 330a and a fourth surface 330b of the metal sheet 330. In an embodiment (not illustrated), the second venting portion 331 may be formed to have a notch shape.

The second venting portion 331 may overlap at least a portion of the first venting portion 311. For example, in an embodiment, a portion of the second venting portion 331 may face the first venting portion 311. Based on a size of the second venting portion 331 facing the first venting portion 311, the direction of discharge of gas, flame, and/or conductive particles generated from a battery cell 100 may be controlled. In another example, the second venting portion 331 may be formed to have a size, identical to a size of the first venting portion 311, and may overlap entirely the first venting portion 311.

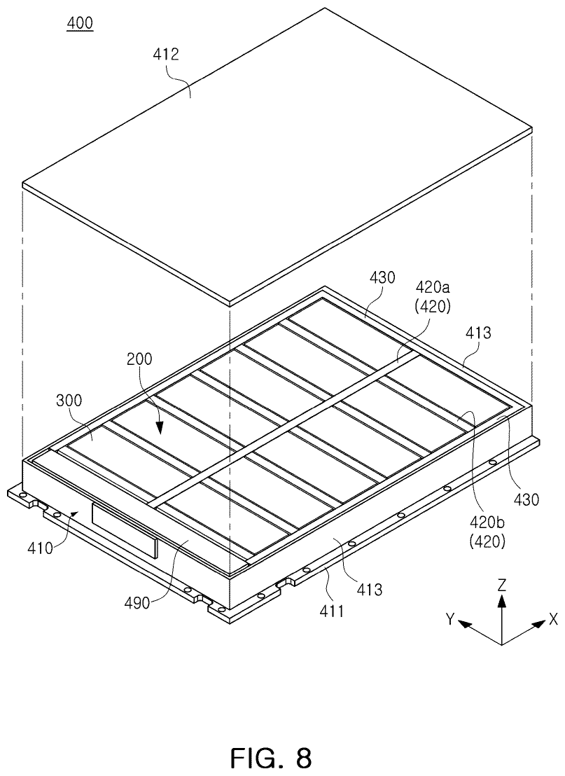

FIG. 8 is an exploded perspective view of a battery pack according to an embodiment.

Referring to FIG. 8, a battery pack 400 may include a plurality of battery modules 200 and a pack frame 410 accommodating the plurality of battery modules 200. The description of the battery module 200 described previously (e.g., FIGS. 2 and 3) may be applied to the battery modules 200 of FIG. 8.

The pack frame 410 may accommodate a component of the battery pack 400 (e.g., battery module 200). The pack frame 410 may include a bottom member 411 supporting a battery module 200, a pack cover 412 covering the battery module 200, and a pack side wall 413 surrounding a space between at least a portion of the bottom member 411 and at least a portion of the pack cover 412. The bottom member 411 may support an accommodating portion (e.g., accommodating portion 212 of FIG. 2) of the battery module 200.

In an embodiment, the contents described for the module cover 300 of FIGS. 4 to 7B may be applied to the pack cover 412. For example, the pack cover 412 may include a support member (e.g., support member 310 of FIG. 4) including a polymer, and a metal sheet (e.g., metal sheet 330 of FIG. 4) disposed on the support member 310.

In an embodiment, a battery pack 400 may include a battery module 200 including a module cover 300, as in FIGS. 4 to 7B, together with the pack cover 412 including the support member 310 and the metal sheet 330.

In an embodiment, a battery module 200 may not include the support member 310 and the metal sheet 330, and the battery pack 400 may include a pack cover 412 including the support member 310 and the metal sheet 330.

The pack frame 410 may include a bulkhead 420 crossing at least a portion of the plurality of battery modules 200. For example, an accommodation space of the pack frame 410 may be divided into a plurality of spaces by the bulkhead 420. The bulkhead 420 may be installed across the accommodation space to reinforce rigidity of the pack frame 410. In an embodiment, the bulkhead 420 may include a first bulkhead 420a crossing a plurality of battery cells 100, and a plurality of second bulkheads 420b, substantially perpendicular to the first bulkhead 420a.

In an embodiment, the battery pack 400 may include a duct member 430. The duct member 430 may include an exhaust space for providing a path for gases and/or flames discharged from the battery module 200. The duct member 430 may be disposed in the pack frame 410. The duct member 430 may surround at least a portion of the battery module 200. For example, gases and/or flames generated from a battery cell of the battery module 200 (e.g., battery cell 100 of FIG. 1) may pass through the exhaust space of the duct member 430 to an outside of the battery pack 400. In the disclosure of this patent document, the duct member 430 may be referred to as an exhaust duct or an exhaust member.

The battery pack 400 may include a battery controller 490 for controlling the battery module 200. The battery controller 490 may be disposed in the pack frame 410. The battery controller 490 may include a battery management system (BMS). Since a configuration of the battery controller 490 may be known in various forms, a detailed description thereof will be omitted. In an embodiment, the battery controller 490 may be referred to as a processor.

A structure of the battery pack 400 of FIG. 8 is illustrative. For example, the number of battery modules 200 included in the battery pack 400, a structure of the pack frame 410 and/or a structure of the duct member 430 may be selectively designed.

The contents described above may be merely examples of applying the principles of the disclosure of this patent document, and other configurations may be further included without departing from the scope of the disclosure of this patent document.

Although embodiments of the disclosure of this patent document have been described above, the scope of the rights of the disclosure of this patent document is not limited thereto, and it will be apparent to those skilled in the art that various modifications and variations are possible within a scope that does not depart from the technical idea of the disclosure of this patent document described in the claims. For example, the disclosure of this patent document may be implemented by deleting some of the components in the above-described embodiments, and each embodiment may be implemented in combination with each other.

According to an embodiment of the disclosure of this patent document, insulation stability and melting stability of a battery module or a battery pack may increase.

According to an embodiment of the disclosure of this patent document, weight of a battery module or a battery pack may be reduced to increase an energy density.

According to an embodiment of the disclosure of this patent document, manufacturing costs and weight of a battery module or a battery pack may be reduced.

Only specific examples of implementations of certain embodiments may be described. Variations, improvements and enhancements of the disclosed embodiments and other embodiments may be made based on the disclosure of this patent document.

What is claimed is:

1. A battery module comprising:
a cell assembly including a plurality of battery cells;
a module housing accommodating the cell assembly; and
a module cover connected to the module housing and covering at least a portion of the cell assembly,
wherein the module cover includes a support member including a polymer, and a metal sheet disposed on the support member, and
the support member is formed to have a first thickness, and the metal sheet is formed to have a second thickness, thinner than the first thickness.

2. The battery module of claim 1, wherein the second thickness is 0.01 mm to 1.0 mm.

3. The battery module of claim 1, wherein the module cover comprises a plurality of venting holes,
wherein each of the plurality of venting holes includes:
a first venting portion formed in the support member, and
a second venting portion formed in the metal sheet and overlapping at least a portion of the first venting portion.

4. The battery module of claim 1, wherein the support member comprises a first uneven pattern, and
the metal sheet comprises a second uneven pattern interlocked with the first uneven pattern.

5. The battery module of claim 1, wherein the polymer comprises at least one of polypropylene, polyethylene, polycarbonate, polycarbonate acrylonitrile butadiene styrene, or modified polyphenylene oxide.

6. The battery module of claim 1, wherein the metal sheet comprises stainless steel.

7. The battery module of claim 1, wherein the metal sheet comprises a through-hole, and
the support member comprises a support portion, and a protrusion portion extending from the support portion and exposed to an outside of the module cover through the through-hole.

8. The battery module of claim 1, wherein the module cover comprises a fastening member connecting the support member and the metal sheet.

9. The battery module of claim 1, wherein the module cover comprises an adhesive layer located between the support member and the metal sheet.

10. The battery module of claim 1, wherein the cell assembly faces at least a portion of the support member, and
the support member is located between the metal sheet and the cell assembly.

11. The battery module of claim 1, wherein a first density of the support member is lower than a second density of the metal sheet.

12. A battery pack comprising:
a plurality of battery modules; and
a pack frame accommodating the plurality of battery modules,
wherein each of the plurality of battery modules includes:
a cell assembly including a plurality of battery cells;
a module housing accommodating the cell assembly; and
a module cover connected to the module housing and covering at least a portion of the cell assembly,
wherein the module cover includes a support member including a polymer, and a metal sheet disposed on the support member.

13. A battery pack comprising:
a plurality of battery modules; and
a pack frame accommodating the plurality of battery modules,
wherein the pack frame includes a bottom member supporting the plurality of battery modules, and a pack cover covering the plurality of battery modules, and
the pack cover includes a support member including a polymer, and a metal sheet disposed on the support member.
